(19) United States
(12) Patent Application Publication
(10) Pub. No.: US 2003/0228401 A1
(43) Pub. Date: Dec. 11, 2003

(54) System and method of using non-volatile microbiocidal application agents

(76) Inventors: Michael D. Newman, Hillsborough, NJ (US); Stephen A. McCormick, Warrington, PA (US); Helmut Dresselhaus, Brisbane (AU)

Correspondence Address: The BOC Group, Intellectual Property Department, 100 Mountain Avenue, Murray Hill, NJ, 07974-2064, US

(21) Appl. No.: 10/164,159

(22) Filed: Jun. 6, 2002

(51) Int. Cl. A23C 1/00

(52) U.S. Cl. 426/320

(57) ABSTRACT

A system and method of treating food products includes applying a non-volatile microbiocidal substance, such as lactic acid, to the food products. The non-volatile microbiocidal substance may be combined with a carrier gas prior to its application, such that the non-volatile microbiocidal substance is suspended within the carrier gas. Alternatively, the non-volatile microbiocidal substance may be heated to vapor prior to its application to the food products. The invention applies the microbiocidal agent to food products while eliminating the hazards associated with volatile gases used as microbiocidal agents.

### BACKGROUND OF THE INVENTION

The invention relates generally to the application of microbiocidal substances to food products. More particularly, the invention relates to the preparation and the use of non-volatile microbiocidal substances as agents for the treatment of food products.

The preservation of perishable products has been, and continues to be, the focus of considerable commercial interest. By extending the shelf life of a food product, economic value can be added to that food product. Approaches to this end are many and varied (e.g., tight control of storage conditions, packaging, post and in situ applications of preservatives) and various combinations of these and other techniques are known and in practice to one extent or another.

In the context of one particular group of food products, namely baked goods (e.g., muffins, crumpets, scones, bagels, cookies, breads, etc.), all of the above techniques are in use. For example, baked goods can be placed in frozen or refrigerated storage, covered with anaerobic packaging, and/or supplemented by the addition of preservatives. When such preservatives are used, the preservative can be added to either a batter or a mix from which the baked goods are prepared. Also, the preservative can be applied to finished baked goods. With respect to the finished baked goods, application of a small amount of the preservative can extend the shelf life of the baked goods from a typical 6-8 days to an extended 14-16 days when all other conditions (e.g., packaging, storage conditions, and the like) are equal. These preservatives can include a wide variety of substances (i.e., microbiocidal substances, antimicrobial substances, etc.) such as acetic acid, carbonic acid, mixtures thereof, and the like.

Current methods of generating and applying microbiocidal substances involve the use of a volatile gas, such as acetic acid, within a carrier gas. Volatile gases by nature are generally hazardous to work with, as they can be explosive under specific conditions.

The nature of volatile microbiocidal agents requires elaborate and costly equipment to be used in order to accommodate the volatile gases. The additional measures required during the design, fabrication, installation and use of equipment to be used with volatile gases can decrease the efficiency and increase the cost of a microbiocidal application process. For example, in order to use volatile gases, the following must be observed: explosion-proof components must be used, adding tremendous cost to the application system; specific procedures must be observed when storing the volatile gases, such storage oftentimes occurring off-site and out of the direct control of the supplier of the volatile gases; and detailed control and strict systems must be implemented to prevent leakage and prevent exposure to those in working with the volatile gases. The leakage of volatile gases can pose a significant risk to plant personnel.

It would be beneficial if the use of volatile gases as microbiocidal agents could be reduced or eliminated. Further, it would be desirable to provide a microbiocidal agent food treatment system that uses non-volatile gases as the microbiocidal agent.

Thus, a system and method for providing treatment to a food product with a nonvolatile gas would be highly desirable since such an apparatus and method would eliminate the need for a volatile gas in the treatment process.

### SUMMARY OF THE INVENTION

The present invention provides for the use of non-volatile microbiocidal substances as agents for the treatment of food products that overcomes the aforementioned problems. In accordance with one aspect of the invention, a method of applying a microbiocidal agent is disclosed. The method includes providing a non-volatile microbiocidal agent, combining the non-volatile microbiocidal agent with a carrier gas to form a non-volatile microbiocidal agent carrier gas formation, delivering the non-volatile microbiocidal agent carrier gas formation to application equipment, and applying the non-volatile microbiocidal agent carrier gas formation with the application equipment.

Various other features, objects and advantages of the present invention will be made apparent from the following detailed description and the drawings.

### BRIEF DESCRIPTION OF THE DRAWINGS

Embodiments of the invention are disclosed with reference to the accompanying drawings and are for illustrative purposes only. The invention is not limited in its application to the details of construction, or the arrangement of the components, illustrated in the drawings. The invention is capable of other embodiments or of being practiced or carried out in other various ways. Like reference numerals are used to indicate like components.

The drawings illustrate at least one mode presently contemplated for carrying out the invention.

In the drawings:

FIG. 1 illustrates a schematic flow diagram of a process for preparing a baked food product;

FIG. 2 illustrates a schematic flow diagram of another process for preparing a baked food product;

FIG. 3 illustrates a schematic flow diagram of one treatment fluid generation system that may be used with the present invention;

FIG. 4 illustrates one embodiment of a non-volatile microbiocidal agent system in accordance with one aspect of the invention;

FIG. 5 illustrates another embodiment of a non-volatile microbiocidal agent system in accordance with one aspect of the invention;

FIG. 6 illustrates a schematic flow chart of one methodology associated with the application of the non-volatile microbiocidal agent in accordance with one embodiment of the present invention; and

FIG. 7 illustrates a schematic flow chart of a methodology associated with the application of the non-volatile microbiocidal agent in accordance with another embodiment of the present invention.

### DETAILED DESCRIPTION OF THE PREFERRED EMBODIMENTS

Although the present invention is described below in the context of applying a treatment fluid containing a preservative (e.g., a mixture of carbon dioxide and a non-volatile microbiocidal substance) to a baked good, the invention can also be employed with, and has applicability to, many different application processes.

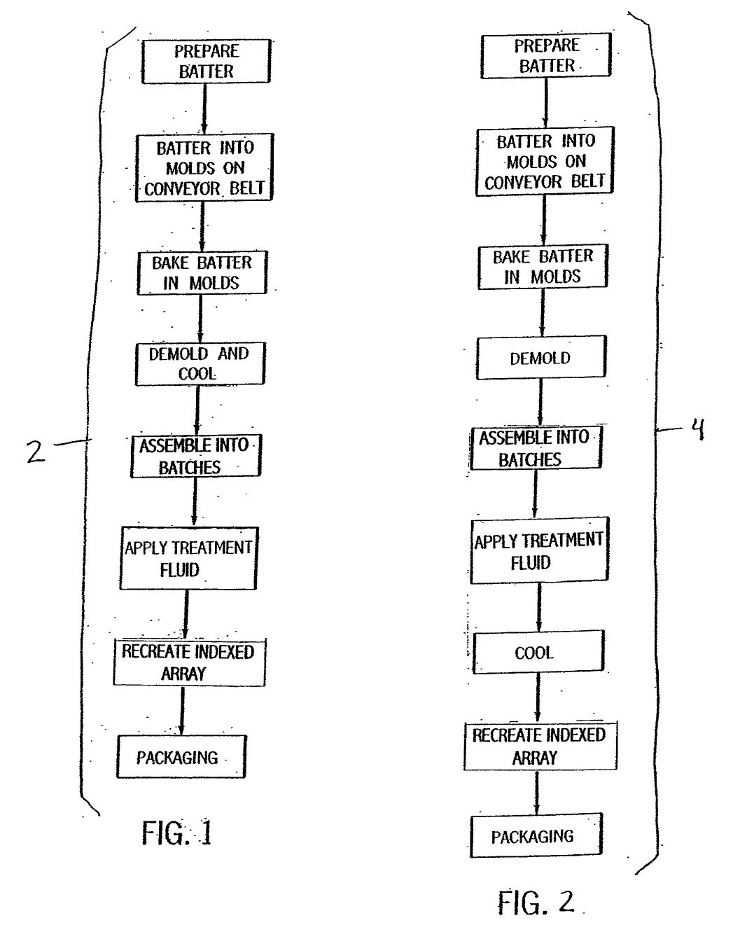

Referring to FIG. 1, an outline 2 is illustrated for preparation of commercial quantities of a food product, namely a baked good (e.g., muffin, crumpet, scone, bagel, cookie, bread, and the like). Batter is prepared and then poured into molds that are either carried on, or form a part of, a conveyor mechanism. The conveyor mechanism moves the batter through a baking zone in which the batter is fully baked.

Upon leaving the baking zone, the baked good is de-molded, typically onto a second conveyor mechanism. The de-molding procedure typically deposits the baked goods upon the second conveyor mechanism such that the baked goods are arranged in an indexed array. The indexed array of baked goods are then conveyed through a cooling tunnel to bring the baked goods to a temperature appropriate for packaging (e.g., room temperature or slightly above).

In some instances as illustrated in FIG. 1, prior to packaging, the baked goods will pass through a treatment apparatus. Prior to encountering the treatment apparatus, the baked goods are assembled into batches. In batches, the baked goods are transported through the treatment apparatus where a treatment fluid containing a preservative is applied to an external surface of the baked goods. Typical preservatives can include a wide variety of substances (i.e., microbiocidal substances, antimicrobial substances, etc.). Preservatives have the ability to radically reduce the pH of food products and, as such, can eradicate and/or eliminate bacteria present within the food product. The treatment fluid can include a preservative or a mixture containing the preservative. For example, a vaporized mixture of carbon dioxide and an application agent can be employed as the treatment fluid.

In other instances, as illustrated by outline 4 in FIG. 2, placement of the cooling tunnel and the treatment apparatus are reversed. In other words, the baked goods are de-molded, assembled into batches, treated with the treatment fluid, cooled, restored to the indexed array, and then packaged.

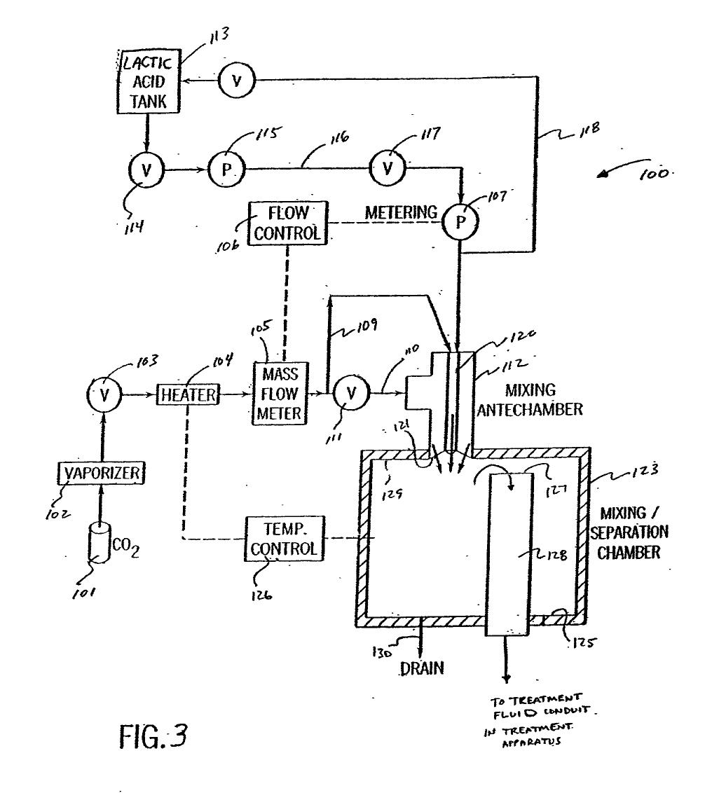

FIG. 3 shows an example of an application agent preparation system 100 that can be adapted for use with the present invention. System 100 is capable of mixing a carrier gas and vaporized liquid with little, if any, entrained droplets. In system 100, tank 101 holds liquid carbon dioxide, typically at about three hundred (300) psig. Liquid carbon dioxide is transferred to vaporizer 102 and converted to a gas substantially free of any droplets. The gas is then passed through pressure reduction valve 103 and the pressure of the gas is reduced from three hundred (300) psig to one hundred (100) psig. The gaseous CO₂ is then transferred to heater 104 and heated to substantially the same temperature as the contents of mixing/separation chamber 123 (e.g., 140° F.). Temperature control unit 126 coordinates the temperature of heater 104 and of chamber 123. From heater 104, the gaseous carbon dioxide at one hundred (100) psig is transferred to mass flow meter 105, which is controlled by flow control 106. As long as pump 107 is in proper operation, flow control 106 allows carbon dioxide to move from mass flow meter 105 into pipe 108. Pipe 108 divides into pipes 109 and 110. While the amount of carbon dioxide each of pipes 109 and 110 will carry can vary to convenience, typically pipe 109 will carry about ten (10) percent and pipe 110 will carry the remaining about ninety (90) percent by weight of the carbon dioxide. The stream of carbon dioxide passing through in pipe 110 can also pass through control valve 111 before entering mixing antechamber 112.

Liquid acid, such as lactic acid, is removed from tank 113 through check valve 114 by the action of pump 115. When lactic acid is used, the liquid lactic acid moves through line 116 and valve 117 into metering pump 107. If atomization nozzle 120 is operational, then the liquid lactic acid is fed into the atomization nozzle where the liquid lactic acid is atomized with carbon dioxide delivered to the nozzle through line 109. If atomization nozzle 120 is not operative, then the liquid lactic acid is returned to tank 113 by way of line 118 and check valve 119.

Atomized lactic acid is transferred from atomization nozzle 120 into the upper section of mixing/separation chamber 123 in which it is vaporized by contact with carbon dioxide delivered from mixing antechamber 112 through orifice plate 121. The carbon dioxide delivered from line 110 into antechamber 112 passes through pressure reduction valve 111 in which the pressure of the carbon dioxide is reduced from one hundred (100) psig to about five (5) psig. The pressure of the atomized lactic acid as delivered to mixing/separation chamber 123 is also about five (5) psig. The temperature, pressure and volume of carbon dioxide introduced into the upper section of mixing/separation chamber 123 is sufficient such that the atomized lactic acid is essentially completely vaporized upon contact with it.

Atomization nozzle 120 passes through antechamber 112 and orifice plate 121, and opens into the upper section of mixing/separation chamber 123. Atomization nozzle 120 can extend into the upper section of mixing/separation chamber 123 to any convenient length, but typically the end of the nozzle is flush with or extends only a short distance beyond orifice plate 121.

Further, commonly-owned, co-pending U.S. patent application Ser. No. ______ entitled “Apparatus and Method for Providing Treatment to a Continuous Supply of Food Product Using a Vacuum Process,” filed simultaneously with the present application, discloses other and various embodiments and components within a fluid generation system and, therefore, the contents and disclosure of these applications are incorporated into the present application by reference as if fully set forth herein.

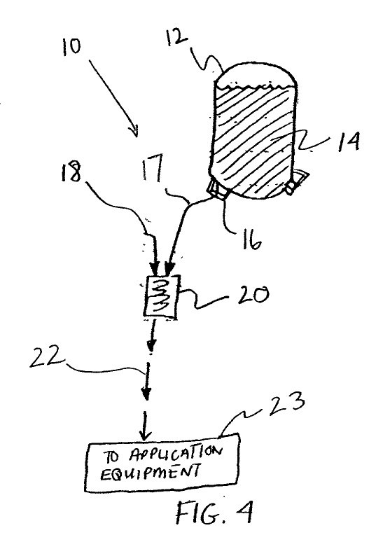

FIG. 4 illustrates one embodiment of a non-volatile microbiocidal agent preparation system in accordance with one aspect of the invention. The microbiocidal agent generation system is shown generally by reference numeral 10. System 10 includes storage tank 12, which provides storage for a non-volatile liquid microbiocidal agent 14. Preferably, non-volatile substances such as lactic acid may be used, although any suitable non-volatile substance, such as compounds including a non-volatile substance, may be used and are contemplated to be within the scope of the invention. The use of a nonvolatile gas as a microbiocidal agent simplifies the generation process.

Additionally, the nonvolatile microbiocidal agent also simplifies the application equipment that will ultimately apply the nonvolatile microbiocidal agent. The controls for the application equipment may be greatly simplified and the explosion proof components may not be required where only nonvolatile gases will be used with the application equipment.

Storage tank 12 includes an outlet 16 for dispensing the liquid form of the non-volatile microbiocidal agent 14. A carrier gas line 18 supplies a carrier gas to be mixed with, or combined with, the liquid non-volatile microbiocidal agent. The non-volatile agent, in the embodiment shown, is combined with a carrier gas, such as carbon dioxide or nitrogen, in mixing chamber 20. A pipe or line 17 connects the outlet 18 with the mixing chamber 20. The resulting mixture or stream 22 is an atomized non-volatile agent suspended within the carrier gas, or non-volatile microbiocidal agent carrier gas formation or combination, that is provided to application equipment 23 for application as a microbiocidal agent.

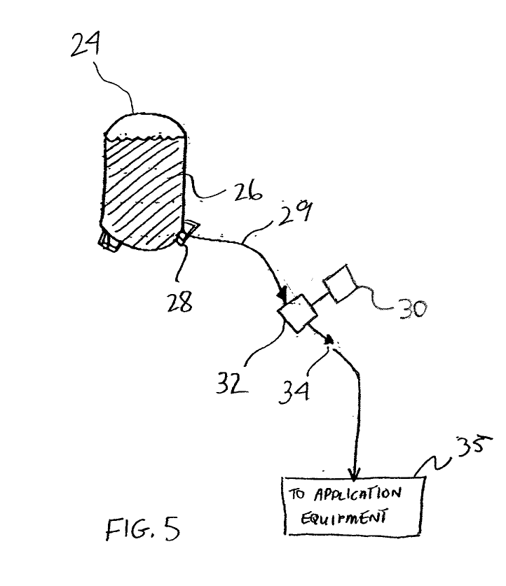

FIG. 5 illustrates another embodiment of a non-volatile microbiocidal agent preparation system in accordance with another aspect of the invention. In this embodiment, a carrier gas is not used. The storage tank 24 also provides a non-volatile microbiocidal agent 26 through outlet 28. It is necessary to heat non-volatile microbiocidal agent 26 in order to convert it from a liquid to a gas. A heat exchange device 30, such as a heat exchanger, is in thermal communication with non-volatile liquid acid line 29. The line 29 is connected to the outlet 28 and is used to transfer non-volatile microbiocidal liquid from storage tank 24 to the device 30. The heat exchanger 30 is used to transfer heat to the non-volatile liquid acid while in chamber 32. Heat is transferred to the liquid non-volatile microbiocidal agent until it vaporizes into a gaseous phase and proceeds as a gas through line 34 until reaching the application equipment 35 where it may be applied to, for example, food products (not shown).

FIG. 6 illustrates a schematic flow chart of one methodology, generally referred to by numeral 200, associated with the application of the non-volatile microbiocidal agent in accordance with one embodiment of the present invention. In this embodiment, the method of applying a microbiocidal gas includes providing or supplying 202 a liquid non-volatile microbiocidal substance, such as an acid; heating 204 the liquid non-volatile microbiocidal acid to form a non-volatile microbiocidal acid vapor; and applying 206 the non-volatile microbiocidal acid vapor.

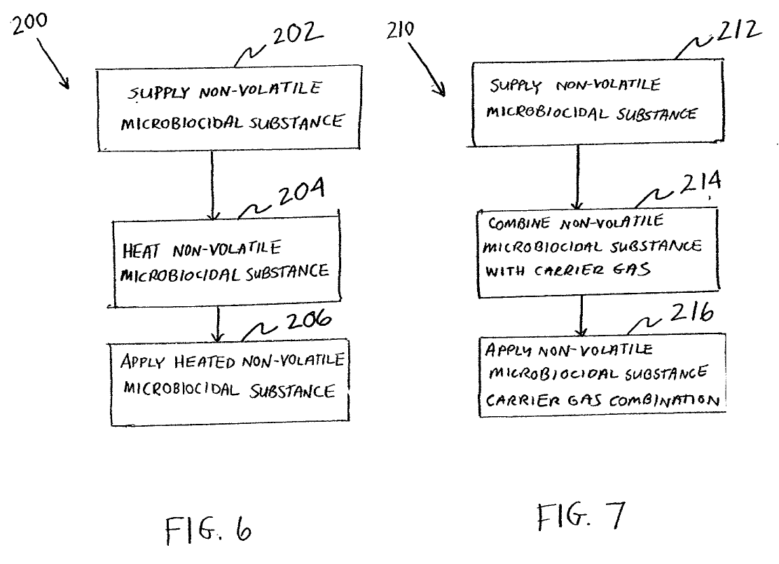

FIG. 7 illustrates a schematic flow chart of a methodology, generally referred to by numeral 210, associated with the application of the non-volatile microbiocidal agent in accordance with another embodiment of the present invention. In this embodiment, the method of applying a microbiocidal gas comprises: providing or supplying 212 a liquid non-volatile microbiocidal substance, such as an acid; combining 214 the liquid non-volatile microbiocidal acid or substance with a carrier gas to form a liquid non-volatile microbiocidal acid carrier gas combination; and applying 216 the liquid non-volatile microbiocidal acid carrier gas combination.

The steps of the methods described and claimed herein are set forth to provide the teachings of best mode and preferred embodiments of the invention, for purposes of clarity and particularity, and are not provided by way of limitation. The steps can be combined, divided, interchanged or otherwise rearranged, and other changes, alterations and modifications are contemplated to be within the scope of the present invention.

The present invention has been described in terms of the preferred embodiment, and it is recognized that equivalents, alternatives, and modifications, aside from those expressly stated, are possible and within the scope of the appending claims.

What is claimed is:

1. A method of applying a microbiocidal agent, comprising the steps of: providing a non-volatile microbiocidal agent;
combining the non-volatile microbiocidal agent with a carrier gas to form a non-volatile microbiocidal agent carrier gas formation;
delivering the non-volatile microbiocidal agent carrier gas formation to application equipment; and
applying the non-volatile microbiocidal agent carrier gas formation with the application equipment.

2. The method according to claim 1, wherein the non-volatile microbiocidal agent is provided as a liquid.

3. The method according to claim 2, wherein the step of combining further comprises the step of: atomizing the liquid of the non-volatile microbiocidal agent when the agent is combined with the carrier gas.

4. The method according to claim 1, wherein the non-volatile microbiocidal agent comprises lactic acid.

5. A method of treating a food product, comprising the step of: applying a non-volatile microbiocidal substance to the food product.

6. The method according to claim 5, further comprising the step of: combining the non-volatile microbiocidal substance with a carrier gas prior to application of the non-volatile microbiocidal substance to the food product.

7. The method according to claim 5, further comprising the step of: heating the non-volatile microbiocidal substance to vaporize the non-volatile substance prior to applying the non-volatile microbiocidal substance to the food product.

8. The method according to claim 7, wherein the step of heating is with a heat exchanger.

9. The method according to claim 5, wherein the non-volatile microbiocidal substance comprises lactic acid.

10. The method according to claim 5, wherein the carrier gas includes a gas selected from the group consisting of carbon dioxide and nitrogen.

11. A method of applying a microbiocidal agent, comprising the steps of:
providing a liquid non-volatile microbiocidal acid agent;
heating the liquid non-volatile microbiocidal acid agent to form a non-volatile microbiocidal acid vapor; and
applying the non-volatile microbiocidal acid vapor.

12. The method according to claim 11, wherein the step of applying the non-volatile microbiocidal acid vapor accomplishes microbial decontamination.

13. A method of applying a microbiocidal gas, comprising the steps of:
providing a liquid non-volatile microbiocidal acid;
combining the liquid non-volatile microbiocidal acid with a carrier gas to form a carrier gas combination; and
applying the carrier gas combination.

14. The method according to claim 13, wherein the step of applying the non-volatile microbiocidal acid carrier gas combination accomplishes microbial decontamination.

15. The method according to claim 13, wherein the step of combining comprises atomizing the non-volatile microbiocidal acid within the carrier gas.

16. A system for applying a microbiocidal agent, comprising:
a storage container for holding a non-volatile microbiocidal liquid;
a line for transferring the non-volatile microbiocidal liquid from the storage container;
a heat exchanger in communication with the line for heating the non-volatile microbiocidal liquid to produce a non-volatile microbiocidal gas; and
application equipment in communication with the heat exchanger for applying the non-volatile microbiocidal gas.

17. A system for applying a microbiocidal agent, comprising:
a storage container for holding a non-volatile microbiocidal liquid;
a gas line for transferring a carrier gas;
a mixing chamber in fluid communication with the storage container and the gas line for mixing the non-volatile microbiocidal liquid and the carrier gas to provide a non-volatile microbiocidal carrier gas agent combinations; and
application equipment in fluid communication with the mixing chamber for applying the carrier gas agent combination.

18. The system according to claim 17, wherein the mixing chamber is adapted to atomize the non-volatile microbiocidal liquid for being suspended in the carrier gas.
